(19) United States
(12) Patent Application Publication
(10) Pub. No.: US 2006/0041938 A1
(43) Pub. Date: Feb. 23, 2006

(54) Method of supporting SSL/TLS protocols in a resource-constrained device

(75) Inventor: Asad Mahboob Ali, Austin, TX (US)

Correspondence Address: ANDERSON & JANSSON L.L.P., 9501 N. CAPITAL OF TX HWY #202, AUSTIN, TX, 78759, US

(73) Assignee: Axalto Inc., Austin, TX (US)

(21) Appl. No.: 10/923,374

(22) Filed: Aug. 20, 2004

(51) Int. Cl. G06F 15/16

(52) U.S. Cl. 726/14

(57) ABSTRACT

System and method for secure communication between a resource constrained device and a remote node over a computer network. The system and method according to the invention supports an SSL/TLS protocol stack on the resource-constrained device by performing at least one optimization step to reduce the resources required to support the SSL/TLS protocol stack on the resource constrained device.

### TECHNICAL FIELD

The present invention relates generally to communications over a computer network and more particularly to cryptographic communication between resource-constrained devices and remote nodes on a computer network.

### BACKGROUND OF THE INVENTION

Secure Sockets Layer (SSL) and its successor Transport Layer Security (TLS) are the de-facto standards for securing communication between web servers and web browsers on the Internet. The SSL and TLS protocols have been implemented on a vast variety of platforms that range from enterprise class servers to small hand-held devices. However, hitherto these protocols have not been deployed on a device as small as a smart card. Some of the low footprint implementations of SSL/TLS libraries and tools kits are listed here along with why they are not suitable for use in resource constrained devices as small as smart cards.

SSL-C Micro Edition toolkit is a C based implementation of the SSL/TLS protocols targeted at small devices with limited resources. It comes as part of RSA Security's BSAFE product line (For more information go to the RSA Security web site at http://www.rsasecurity.com, and search for SSL-C). SSL-C ME is targeted for platforms such as Windows CE, Palm, etc. However, its memory footprint and architecture cannot be extended for use in smart cards. For example, it automatically expands the size of read/write buffers to accommodate the size of TLS records, using as much as 32K RAM for the buffers alone (RSA BSAFE, SSL-C Micro Edition Developer's Guide, version 1.1.0, by RSA Security). Such a use of memory buffers does not work for resource-constrained devices such as smart cards, where RAM resources are extremely limited; on the order of only a few kilobytes.

Wedgetail Communications of Brisbane, Australia has a Java based product called JCSI Micro Edition SSL for CLDC/MIDP. It implements SSL 3.0 and TLS 1.0 protocols and adds HTTPS support to CLDC via standard CLDC connection interface. CLDC is the foundation for Java runtime environment targeted at small resource constrained devices such as mobile phones, pagers, and PDAs, but currently it is not targeted at devices as small as smart card. The CLDC 1.1 specification assumes at least 32K of volatile memory for VM runtime alone, with RAM still needed for SSL context and I/O buffers. Therefore, this Wedgetail Communication product cannot be adapted for use in smart cards. Information about their JCSI Micro Edition SSL toolkit can be found at their website at http://www.wedgetail.com/jcsi/microedition/ssl/midp/index.html.

Security Builder SSL (formerly known as SSL Plus Embedded) is an SSL toolkit for developing secure network solutions based on SSL 2.0, SSL 3.0 and TLS 1.0 protocols. It was developed by Certicom Corporation of Mississauga, Ontario, Canada. The target platforms include Palm, Windows CE, and VxWorks. The static library for SSL Plus Embedded requires about 70K. Although acceptable for other embedded devices, the RAM requirement of this library is too big for smart cards. Information about this toolkit can be found at Certicom's website at http://www.certicom.com.

DeviceSSL is an SSL protocol implementation with optional support for TLS protocol. Developed by SPYRUS Inc. of San Jose, Calif., DeviceSSL serves as a toolkit for building secure network solutions for small, connected devices. It is targeted for devices like PDA and RTOS applications on the network, but not for smart cards. The code footprint for DeviceSSL is about 100K on server side. The RAM requirement is unsuitable for a smart card. Information about this product is available at: http://www.spyrus.com/content/products/Terisa/DeviceSSL.asp.

From the foregoing it will be apparent that there is still a need for an improved method to provide support for cryptographic communications protocols such as SSL/TLS on resource-constrained devices so as to enable secure communications end-to-end between the resource-constrained device and the remote node.

### SUMMARY OF THE INVENTION

Due to the heavy resource requirements of SSL/TLS protocol stacks, and the cryptographic computations associated with them, the use of SSL/TLS has so far been considered the realm of large enterprise systems, or relatively small hand-held devices. This invention describes a method where by the SSL/TLS protocols can be supported inside a resource-constrained device as small as a smart card. The invention is based on an optimized software design where the limited RAM resources of a smart card are conserved using a set of memory manipulation techniques.

### BRIEF DESCRIPTION OF THE DRAWINGS

FIG. 1 is a block diagram illustrating the overall layering of a security layer 100 and application program interface with respect to other components as implemented according to the invention in a resource-constrained device.

FIG. 2 is a block diagram of the sub-components of the security layer module according to the present invention.

FIG. 3 is a schematic illustration providing an exemplary illustration of the use of random access memory (RAM) and non-volatile memory (NVM) on a resource-constrained device, in particular, the use of contiguous heap areas on RAM and NVM according to the invention

FIG. 4(a) is a schematic illustration of an example of free and allocated blocks in the contiguous area of memory reserved for a RAM heap located on the RAM.

FIG. 4(b) is a schematic illustration of a linked list linking free blocks in the RAM heap.

FIG. 5(a) is a schematic illustration of the state of the RAM heap a new block has been allocated.

FIG. 5(b) is a schematic illustration of the logical linking of free blocks in the RAM heap of FIG. 5(a).

FIG. 6(a) is a schematic illustration of an exemplary state of the RAM heap 302 after a previously allocated block 404 has been freed.

FIG. 6(b) is a schematic illustration showing the logical linking of the available free blocks in RAM heap of FIG. 6(a).

FIG. 7(a) is a block diagram illustrating the sub-components of the TLS server handshake module.

FIG. 7(b) is a block diagram illustrating the sub-components of the TLS client handshake module.

FIG. 8(a) is a block diagram illustrating the sub-components of the SSL server handshake module.

FIG. 8(b) is a block diagram illustrating the sub-components of the SSL client handshake module.

FIGS. 9(a) through 9(e) are illustrations showing a sequence of steps through which the contents of a RAM buffer are swapped to NVM heap.

FIG. 10 is a message flow diagram illustrating the exchange of messages between a client and a server during a typical TLS handshake phase.

FIG. 11 is a flow chart illustrating the sequence of generating a hash (digest) output value from a series of data updates.

FIG. 12 is a flow chart illustrating the sequence of generating an intermediate hash output value, and then a final hash output value from a single hash context: thus saving RAM buffers.

FIG. 13 is a schematic illustration showing the formatting of application data in TLS records.

FIG. 14 is a schematic illustration of the problem of processing a large TLS record using a small I/O buffer.

FIG. 15 is a flow chart of a first method, the performance critical approach, whereby a large TLS record can be processed using a small I/O buffer with preference given to performance.

FIG. 16 is a flow chart of a second method, the error critical approach, whereby a large TLS record can be processed using a small I/O buffer with preference given to avoiding errors.

FIG. 17 is a message flow diagram showing the exchange of messages between a client and a server during a typical SSL version 2.0 handshake phase.

FIG. 18 is a schematic illustration of the operating environment in which a resource-constrained device according to the invention may be used to provide secure communication with a remote entity.

FIG. 19 is a schematic illustration of an exemplary architecture of a resource-constrained device 1801.

FIG. 20(a) shows the steps involved in a typical allocation, use, and free cycle.

FIG. 20(b) shows how an allocated buffer can be reused multiple times before it is freed.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Introduction

As shown in the drawings for purposes of illustration, the invention is embodied in a novel resource-constrained device for secure communications with remote nodes over a computer network. Such a resource-constrained device provides an implementation of a secure communications protocols that may be accessed using standard communications programs from the remote nodes by performing certain optimizations unique to the resource-constrained device.

Even when implemented on enterprise systems with abundant system resources, the SSL/TLS protocols add a considerable overhead in terms of performance as well as computational requirements. This is particularly true during the initial handshake phase when both client and server are engaged in a flurry of activity. This activity consists of authenticating each other, selecting a cipher suite and finally computing various session keys.

On a resource constrained device like smart card; the effects of this overhead are even more drastic. The biggest challenge is conservation of RAM, an extremely scarce resource on smart cards. This invention uses several design optimization techniques that enable the implementation of SSL/TLS stack on a smart card. With these optimizations the combined RAM footprint of TLS protocol and cryptographic layer is only 1.5 kilobytes. Both the client and server parts of the SSL/TLS stacks are implemented. The TLS server side implementation allows the smart card to act as a secure web server. Client applications on the Internet, such as standard web browsers, can connect to the web server on the smart card using HTTPS protocol. The TLS client side implementation allows the smart card to initiate a secure HTTPS connection to a remote web server on the Internet.

Design Overview

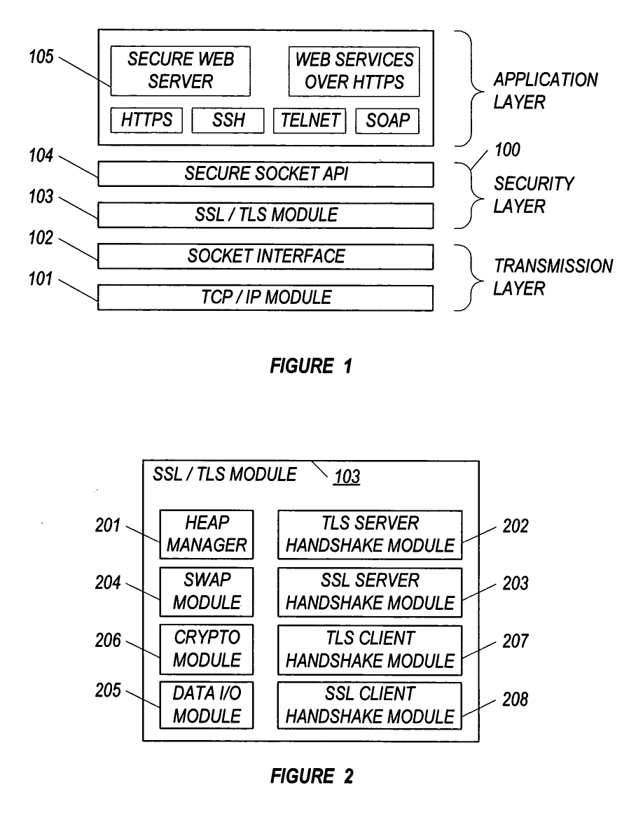

FIG. 1 is a block diagram illustrating the overall layering of a security layer 100 and application program interface with respect to other components as implemented according to the invention in a resource-constrained device. The security layer 100 consists of an SSL/TLS module 103 and a secure socket API layer 104. The SSL/TLS module 103 uses an underlying layer of reliable bi-directional communication. Such a layer may be provided by a standard socket interface 102 built on top of a standard TCP/IP stack 101. Application programs, such as web services, in the resource-constrained device may use the secure socket API 104 to encrypt communication with any remote application that communicates according to the SSL/TLS protocol. For example, a secure web server application 105 may be implemented on the resource-constrained device. Any standard Internet web browser executing on a remote node can then access the secure web server application 105 using the HTTPS protocol.

FIG. 2 is a block diagram of the sub-components of the security layer module according to the present invention. The SSL/TLS module 103 in a resource-constrained device is built using various specialized sub-components. These components are illustrated in FIG. 2. A brief description of each of these components is given below. With the exception of the Crypto Module 206, which can be supported in either software or hardware, all other components are typically implemented in software. Details regarding how these components work are described below in conjunction with specific design optimization techniques.

A Heap Manager 201 is responsible for allocation, de-allocation, and compaction of memory blocks in the contiguous area of RAM heap 302, as well as NVM heap 311. Other sub-components can request the Heap Manager 201 to allocate a new memory block of required size, or to free a previously allocated block of memory. The Heap Manager 201 is a critical tool in the optimization of limited memory resources in a resource-constrained device.

The Swap Module 204 handles the task of moving the contents of a RAM buffer to a buffer allocated on the NVM heap 311. Once the utilization of this freed RAM buffer is complete, the previous contents of the RAM buffer are restored from the NVM heap 311.

The TLS Server Handshake (TSH) module 202 handles the message exchange with a client using TLS 1.0 protocol. As a result of this handshake, a set of session keys is established, and a secure connection is created with the client. These session keys are then used for the encryption and decryption of application data between the resource-constrained device and the remote client. The use of TLS 1.0 protocol is the preferred embodiment of this invention.

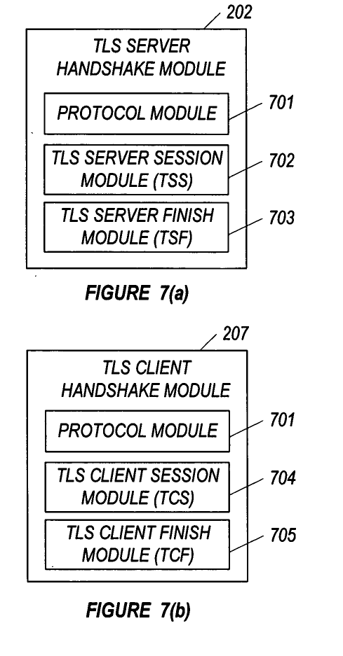

FIG. 7(a) shows the sub-components of the TLS server handshake module 202. This module performs the task of doing a TLS handshake with a remote TLS client application. Once the handshake completes, the resource constrained device and the remote TLS client application have established a set of session keys and security parameters than can be used for exchanging application data. These sub-components consist of the following:

Protocol Module 701. This module determines the exact SSL/TLS protocol version being negotiated between the client and the server.

TLS Server Session (TSS) Module 702. This module is responsible for establishing the session keys which are then used for application data exchange. TLS Server Finish (TSF) Module 703. This module handles the parsing of client-finish message 1007, and then the creation and transmission of server-finish message 1009. The TSF Module 703 makes sure that the handshake between the resource-constrained device and the remote TLS client application has not been compromised.

The TLS Client Handshake (TCH) module 207 handles the message exchange with a server using TLS 1.0 protocol. As a result of this handshake, the resource-constrained device authenticates the remote server and establishes a set of session keys. These session keys are then used for the encryption and decryption of application data between the resource-constrained device and the remote server.

FIG. 7(b) shows the sub-components of the TLS client handshake module. This module performs the task of doing a TLS handshake with a remote TLS server application. Once the handshake completes, the resource constrained device and the remote TLS server application have established a set of session keys and security parameters than can be used for exchanging
application data. These sub-components consist of the following:

Protocol Module 701. This module determines the exact SSL/TLS protocol version being negotiated between the client and the server.

TLS Client Session (TCS) Module 704. This module is responsible for establishing the session keys that are then used for application data exchange.

TLS Client Finish (TSF) Module 705. This module handles the parsing of server-finish message 1009, and the creation and transmission of client-finish message 1007.

The TCF Module 705 makes sure that the handshake between the resource constrained device and the remote TLS server application has not been compromised.

The SSL Server Handshake (SSH) module 203 handles the message exchange with a client using SSL 2.0 protocol. As a result of this handshake, a set of session keys is established, and a secure connection is created with the client. These session keys are then used for the encryption and decryption of application data between the resource-constrained device and the remote client.

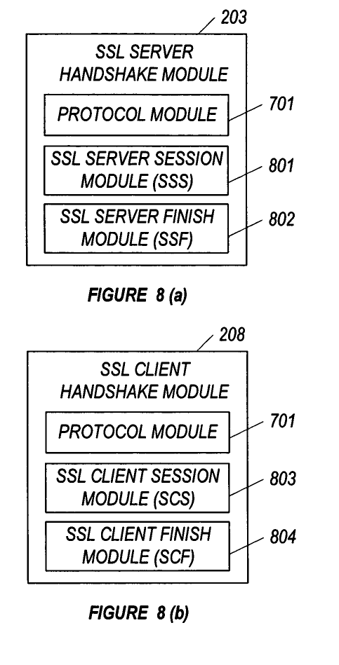

FIG. 8(a) shows the sub-components of the SSL server handshake module. This module performs the task of doing an SSL handshake with a remote SSL client application. Once the handshake completes, the resource constrained device and the remote SSL client application have established a set of session keys and security parameters than can be used for exchanging

application data. These sub-components consist of the following:

Protocol Module 701. This module determines the exact SSL/TLS protocol version being negotiated between the client and the server.

SSL Server Session (SSS) Module 801. This module is responsible for establishing the session keys which are then used for application data exchange using SSL protocol.

SSL Server Finish (SSF) Module 802. This module handles the parsing of client-finish message 1705, and then the creation and transmission of server-finish message 1706. The SSF Module 802 makes sure that the handshake between the resource constrained device and the remote SSL client application has not been compromised.

The SSL Client Handshake (SCH) module 208 handles the message exchange with a server using SSL 2.0 protocol. As a result of this handshake, the resource-constrained device authenticates the remote server and establishes a set of session keys. These session keys are then used for the encryption and decryption of application data between the resource-constrained device and the remote server.

FIG. 8(b) shows the sub-components of the SSL client handshake module. This module performs the task of doing an SSL handshake with a remote SSL server application. Once the handshake completes, the resource constrained device and the remote SSL server application have established a set of session keys and security parameters than can be used for exchanging application data. These sub-components consist of the following:

Protocol Module 701. This module determines the exact SSL/TLS protocol version being negotiated between the client and the server.

SSL Client Session (SCS) Module 803. This module is responsible for establishing the session keys which are then used for application data exchange using SSL protocol.

SSL Client Finish (SCF) Module 804. This module handles the parsing of server-finish message 1706, and the creation and transmission of client-finish message 1705. The SCF Module 804 makes sure that the handshake between the resource constrained device and the remote SSL server application has not been compromised.

Modules 203 and 208 enable the SSL 2.0 protocol to be used in resource-constrained devices that have extremely limited cryptographic capabilities. Examples of such devices can be smart cards without a strong cryptographic library or a cryptographic co-processor.

The Data I/O Module 205 handles the encryption and decryption of application level data once the session keys have been established by a corresponding handshake layer: 202, 203, 207, or 208. The primary task of the Data I/O module 205 is to use various buffer management techniques so that larger data sets can be processed using a very limited I/O buffer.

Crypto Module 206 supports various cryptographic algorithms that are used in the implementation of SSL/TLS protocols. Examples of these algorithms are: RSA for authentication and key exchange, DES and 3-DES for symmetric encryption, HMAC for hashed MAC, and MD-5 and SHA-1 for message digest. The Crypto Module 206 can be supported in either software or hardware. Preferred embodiments of this invention support the crypto module 206 in either a crypto co-processor, or a fast dedicated library.

For reader's convenience overviews of the SSL and TLS protocols are provided in the Appendix section of this document: TLS 1.0 in Appendix A, and SSL 2.0 in Appendix B. However, additional details of the SSL and TLS protocols are not covered in this document. Since both these protocols are standard Internet protocols, their descriptions can be found in various books and RFCs. For example:

Thomas, Steven A., SSL and TLS Essentials, Securing the Web, 2000 John Wiley & Sons, Inc. ISBN 0-471-38354-6, the entire disclosure of which is incorporated herein by reference.

Rescorla, E., SSL and TLS, Designing and Building Secure Systems, 2001 Addison-Wesley. ISBN 0-201-61598-3, the entire disclosure of which is incorporated herein by reference.

Dierks, T., Allen, C., “The TLS Protocol, Version 1.0”, IETF Network Working Group. RFC 2246, the entire disclosure of which is incorporated herein by reference. See the URL http://www.ietf.org/rfc/rfc2246.txt.

SSL version 2.0 specification document at the Netscape website http://wp.netscape.com/eng/security/SSL_{—}2.html, the entire disclosure of which is incorporated herein by reference.

Design Optimizations

The following design optimizations are implemented to support the SSL/TLS stack on a resource-constrained device. Each of these techniques is described in a separate section.
1. Memory management
2. Buffer reuse
3. Swapping to NVM
4. Message Authentication Code (MAC) computations
5. Reading application data
6. TLS Application Program Interface (API)

1. Memory Management

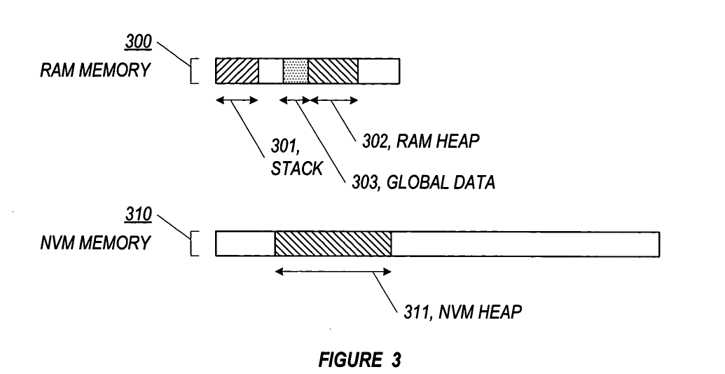

FIG. 3 is a schematic illustration providing an exemplary illustration of the use of random access memory (RAM) and non-volatile memory (NVM) on a resource-constrained device, in particular, the use of contiguous heap areas on RAM and NVM according to the invention. The goal of memory management is to judiciously use the scarce RAM resources in resource-constrained devices; for example, smart cards. As shown in FIG. 3, a smart card has two types of memory areas that can be written to: a faster but very scarce RAM area 300, and a more abundant but much slower NVM (non-volatile memory) area 310. Process variables reside in RAM area 300 and can occupy one of the following three regions: the stack region 301, the RAM heap 302, or the global data area 303.

A process stack area 301 is used for allocation of all local variables defined inside a function that is currently running. The process stack area 301 also holds all the arguments that are passed during a function call. The local variables, and the function arguments need to be kept in memory until the function returns. A function can call other functions, which in turn can call other functions. This nested invocation of functions is called the call stack. As the call stack gets too deep, there is a requirement to increase the size of stack area 301. However, since stack cannot shrink once it has been allocated, much of the stack area 301 may remain unused after the single deep call has completed. Therefore, increasing the size of the stack area 301 is not desirable for devices with limited RAM resources.

The design of SSL/TLS module 103 uses a very small stack area 301. This is achieved by removing all possible local variables, reducing the call stack depth, and cutting down the amount of data that is passed between function calls. Instead of using local variables, most variables are allocated on the RAM heap 302. This allows a much more fine-grained control over management of buffers at runtime. Buffers are allocated as needed by an application, and once used, can be freed for use by some other application. In addition, a separate NVM heap 311 is used when swapping bulk data. This swapping technique, described in section 3 below, further optimizes the utilization of limited RAM.

The Heap Manager:

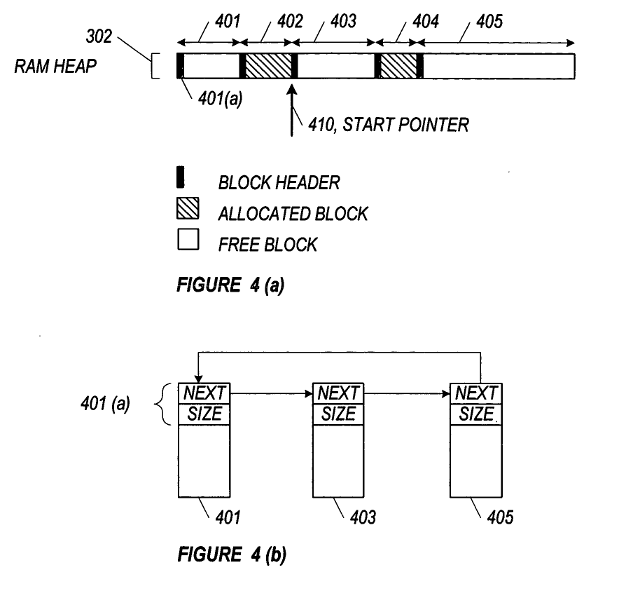

FIG. 4(a) is a schematic illustration of an example of free and allocated blocks in the contiguous area of memory reserved for a RAM heap located on the RAM. The allocation and de-allocation of buffers from RAM heap 302 is done through the heap manager module 201, which is a sub-component of the SSL/TLS module 103. Thus, whenever a module, e.g., the TLS Server Handshake Module 202, the SSL Sever Handshake Module 203, the TLS Client Handshake Module 207, or the SSL Client Handshake Module 208 requests an allocation or deallocation of a RAM buffer, such module 202, 203, 207, or 208 calls upon the Heap Manager 201 to manage that RAM buffer allocation or deallocation.

The Heap Manager 201 divides the RAM heap 302 into a set of blocks. An example of this division is shown in FIG. 4(a). These blocks are marked as allocated (e.g. blocks 402, 404) or available (e.g. blocks 401, 403, 405). The available blocks represent free space in the RAM heap 302 which can be allocated as new requests for memory buffers are received by the heap manager module 201.

The first few bytes of each block contain the block header (e.g. 401(a)). The block header contains two things: the size of current block, and a pointer to the location of the next free block. Using this pointer mechanism the free blocks inside RAM heap 302 can be logically chained together as a singly linked list. FIG. 4(b) is a schematic illustration of a linked list linking free blocks in the RAM heap. The three free blocks (401, 403, and 405) form a circular linked list, which can be traversed by the heap manager to find available RAM buffers. The starting point of the free block traversal is a global pointer called Start Pointer 410. The heap manager keeps track of the location of this pointer.

Allocation of Buffer:

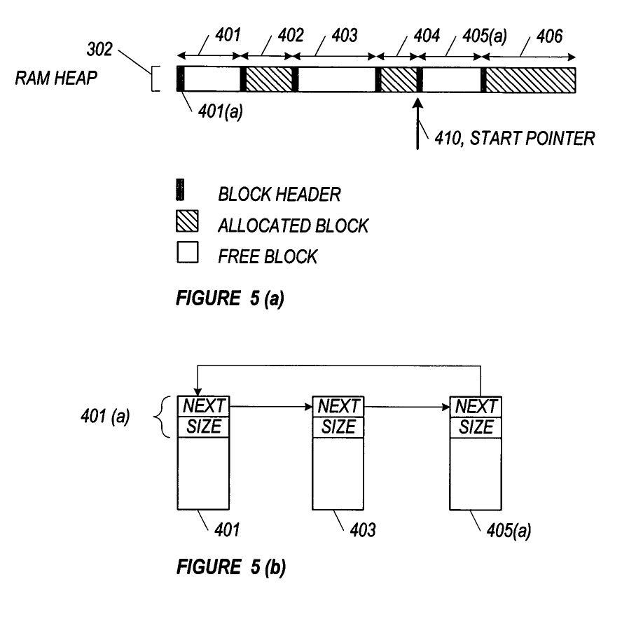

FIG. 5(a) is a schematic illustration of the state of the RAM heap 302 a new block 406 has been allocated. This transformation takes place using the following logic:

The heap manager 201 receives a request to allocate a new memory buffer of size N bytes from the RAM heap 302.

The heap manager 201 starts the search for free space from the Start Pointer 410. Currently, this pointer is at block 403. However, the size of block 403 is less than N bytes. Therefore, the search moves to the next free block, which is block 405.

Block 405 is large enough to allocate the new buffer. This new buffer, block 406, is allocated at the tail end of block 405. The new buffer is now returned to the caller.

Block 405 (represented by block 405(a) in FIG. 5(a)) is now of a smaller size due to this allocation. The header of the block is updated to reflect the new size.

The location of Start Pointer 410 is updated to point to block 405(a).

This approach is called first-fit approach, where the first free block that is large enough is selected for the allocation of buffer. Other approaches are also possible. However, since it reduces the search time, the first-fit approach is more suitable for resource-constrained devices. In case none of the free blocks is large enough to allocate a buffer of size N bytes, the heap manager 201 returns an error code. FIG. 5(b) is a schematic illustration of the logical linking of free blocks in the RAM heap of FIG. 5(a).

De-allocation of Buffer:

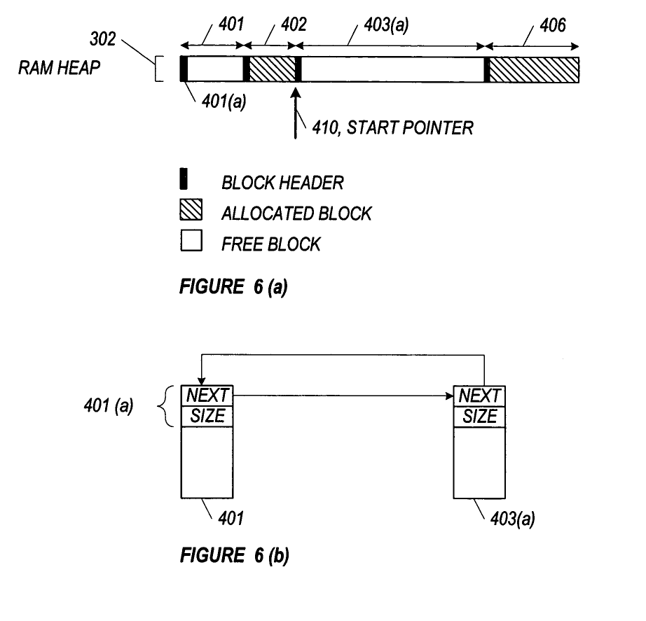

FIG. 6(a) is a schematic illustration of an exemplary state of the RAM heap 302 after a previously allocated block 404 has been freed. This transformation from FIG. 5(a) to FIG. 6(a) takes place using the following logic:

The Heap Manager 201 receives a request to free a previously allocated block 404. The heap manager checks the address of the pointer to block 404 to verify that the block was indeed allocated from the RAM heap 302.

The block 404 is marked as free.

The Heap Manager 201 now checks the two adjacent blocks on each side of block 404 to see if they are also free. If they are, the adjacent free blocks are combined to form a single large free block. In this case both 403 and 405(a) are free so they are combined to form a new block 403(a) of larger size. The size field of the block header is updated to reflect the new size. FIG. 6(b) is a schematic illustration of the logical linking of free blocks in the RAM heap of FIG. 6(a).

The Heap Manager 201 uses the same allocation and de-allocation techniques when managing the NVM heap 311. The NVM heap 311 is useful for larger buffers that do not have to be updated frequently.

2. Buffer Reuse

The heap manager 201 allows a very fine-grained control over dynamic buffer management. However, each allocation and de-allocation of a buffer from the RAM heap 302 has a performance overhead associated with it. A resource-constrained device is limited not only in its RAM resources, but also in the processing power of its CPU. Moreover, each buffer allocation fragments the RAM heap space 302. When the buffer is freed, the heap manager 201 compacts the available free blocks by combining adjoining free blocks into a single larger free block. However, this approach may not be able to resolve heap fragmentation as buffers of varying sizes are repeatedly allocated and freed.

To solve this performance overhead and heap fragmentation problem, the SSL/TLS module 103 uses a concept of buffer reuse. An allocated buffer is used in more than one context without being freed. This is an additional optimization of the dynamic heap management.

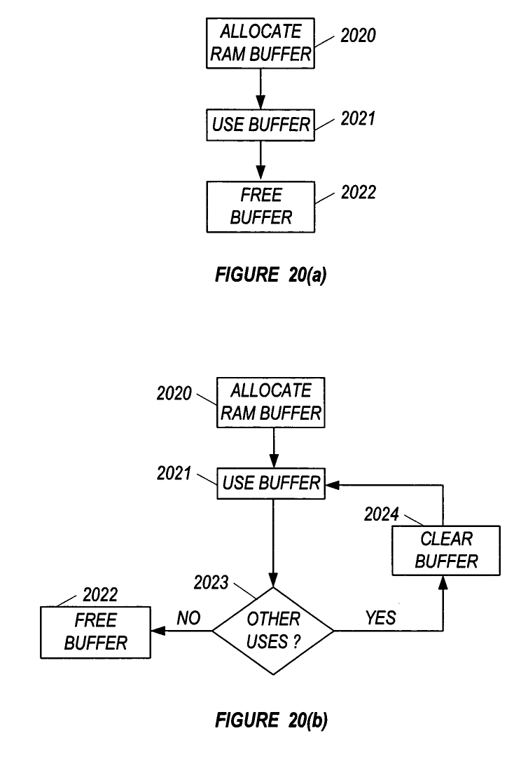

An overview of this additional optimization is shown in FIG. 20(b).

FIG. 20(a) is a schematic illustration showing the sequence of steps in an un-optimized buffer use. After allocation of a buffer from RAM heap (step 2020) the buffer is used in some computation (step 2021). Once the computation is completed, the buffer is freed, step 2022. Now a new buffer has to be allocated from the heap manager 201 in case another computation is desired.

FIG. 20(b) is a schematic illustration showing the sequence of steps in an optimized buffer user. After allocation of a buffer from RAM heap (step 2020) the buffer is used in some computation (step 2021). Once the computation is completed, the calling application checks to see if it has some other independent computation that requires a RAM buffer, step 2023. If so, the current buffer is cleared (step 2024) and then reused (step 2021). If, however, the calling application has no more immediate use for the buffer, the buffer is freed (step 2022).

To avoid accidental buffer corruption, the buffer reuse technique has to be used carefully. In one embodiment of the invention, some examples of buffer reuse by the SSL/TLS module 103, and its sub-components, are given below:

During the TLS handshake phase, a pre-master secret and a master secret are stored in a single common buffer. Although both values are critical during the TLS handshake, they are not used at the same time. Once the master secret value has been computed from the pre-master secret value, the latter can be discarded. This property allows a single RAM buffer to be allocated for both the pre-master secret and the master secret.

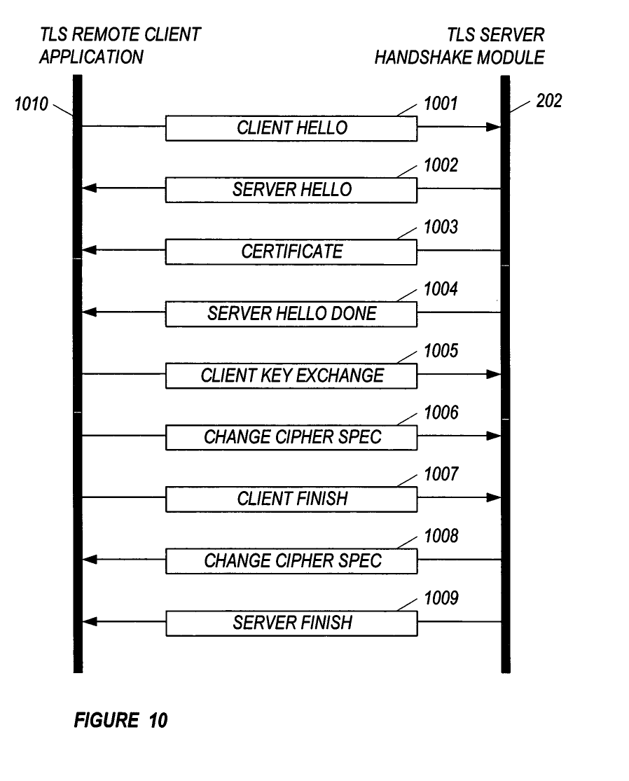

While processing the client-key-exchange message (described in greater detail below in conjunction with FIG. 10), the value of the encrypted pre-master secret is not copied to a separate buffer. Instead it is kept in the same global I/O buffer that is used for reading all incoming TLS records. The 6th byte of this I/O buffer is the starting point of encrypted pre-master secret data. The length of this encrypted data is same as RSA key size; e.g. 128 bytes for a 1024-bit RSA key. As such, the subsequent RSA decryption operation is performed by treating the 6th byte of the I/O buffer as the start of cipher text input data. In a preferred embodiment of this invention the TLS server handshake (TSH) module 202 includes logic to ensure that the data in the I/O buffer is not modified until the RSA decryption is complete.

When performing DES encryption and decryption, a single RAM buffer is used for both input and output. DES operations in CBC mode are performed on 8-byte block boundaries. Once the input data is used for an 8-byte computation, it is not needed for subsequent computations. As such it is safe to store the output value in the same buffer. This eliminates the overhead of allocating an additional buffer for DES computation. Another example of buffer reuse in different contexts is the sharing of the same buffer among different layers of the SSL/TLS module 103. For example, the data I/O module 205, the TSH module 202, and the secure socket API 104 can use a single common buffer for exchanging data with each other.

3. Swapping to NVM

While the buffer reuse technique reduces the RAM footprint in most cases, it does not cover all scenarios of memory management. For example, during the TLS handshake process a lot more information needs to be kept in memory than the available RAM area 300 will allow. In these situations a preferred embodiment of this invention swaps unused data from the RAM area 300 to the NVM heap 311 of the smart card. In resource-constrained devices like smart cards, the NVM heap 311 is much more abundant than the limited RAM area 300. The swapped RAM buffer can now hold some other data values and can perform a different set of computations. Once this set of computations is complete, the swapped data is reloaded from the NVM heap 311 and the RAM context is restored to its original state.

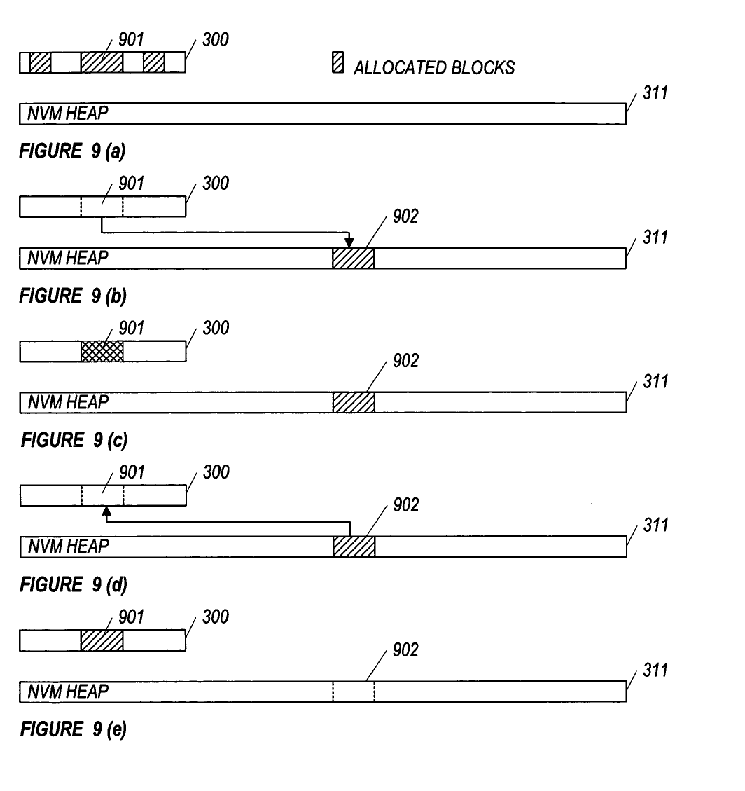

FIGS. 9(a) through 9(e) are illustrations showing a sequence of steps through which the contents of a RAM buffer are swapped to NVM heap 311, and then restored at a later time. Explanation of these steps is given below:

FIG. 9(a). This is the initial state before swapping. A buffer 901 has been allocated in the RAM area 300, either from the RAM heap 302, or from the global data pool 303. Buffer 901 contains some intermediate results of a computation.

FIG. 9(b). Some other process in the SSL/TLS module 103 requires a RAM buffer. However, due to the limited RAM resources, no contiguous large enough buffers are available in the RAM area 300. Therefore, the swap module 204 picks an existing buffer 901 for swapping. A new buffer 902 is allocated in the NVM heap 311. The swap module writes the contents of buffer 901 to buffer 902. Buffer 901 is now cleared for use by another process.

FIG. 9(c). The buffer 901 is given to another process and a new set of data is written to it.

FIG. 9(d). Once the new computations on the data in buffer 901 are complete, buffer 901 is cleared.

FIG. 9(e). The swap module 204 now reads the saved contents of buffer 901 from the buffer 902 in NVM and writes them to buffer 901. This restores buffer 901 to its original state.

The technique of swapping data from RAM area 300 to NVM heap 311 may appear to be an all-encompassing solution that can solve the problems associated with limited RAM resources. However, swapping needs to be studied carefully and applied in a calculated manner. There are two reasons for this. Firstly, the buffers that are swapped should be large enough to justify the overhead of swapping, but at the same time should be disjoint enough so that they do not need to be in RAM concurrently. Secondly, swapping to NVM heap 311 is a performance critical operation. While reading from NVM may take the same amount of time as reading from RAM, writing to NVM is much slower. As such swapping to NVM should be used in only those situations that justify this overhead.

In the preferred embodiment of this invention, swapping to NVM heap 311 is done while decrypting pre-master secret using the RSA private key. The decision to swap at this stage of TLS handshake meets the above identified criteria for buffer swapping. During decryption of the pre-master secret, two distinct buffers are vying for RAM resources, but they do not need to use the RAM simultaneously. These two buffers are the TLS context buffer and the RSA context buffer. The TLS context buffer holds information about the state of TLS handshake, whereas the RSA context buffer is used by the crypto module 206 to decrypt the pre-master secret. Both these buffers consume a considerable amount of RAM. On a resource-constrained device such as a smart card, it may not be possible to allocate both these buffers at the same time. To overcome this problem the swap module 204 swaps the contents of the TLS context buffer to NVM heap 311. The RAM space occupied by the TLS context buffer can now be used for holding the RSA context. The crypto module performs the pre-master decryption using this buffer. Once the decryption is complete, the swap module 204 restores the contents of the TLS context from NVM heap 311.

In the scenario described above the overhead of swapping to NVM heap 311 is justified because of three main reasons:

First, both the TLS context buffer and RSA buffer use considerable RAM, and not using the swapping approach would increase the overall RAM requirement of the SSL/TLS module 103 by more than 512 bytes. This can be a considerable increase given the limited RAM in a resource-constrained device.

Second, RSA decryption is done only during the full handshake in both SSL and TLS protocols. This happens when a client browser connects to the SSL/TLS server for the first time. After this, each subsequent connection uses partial handshake. In partial handshake the previously exchanged master secret is reused to generate a new set of session keys. Since a new master secret is not exchanged between the client and the server, there is no need to perform the costly RSA decryption. The performance overhead of swapping is acceptable since it does not occur that frequently.

Finally, the RSA decryption by itself is a computationally intensive process that requires considerable time. The relative time spent in swapping the RAM buffer to the NVM heap 311 may only be a fraction of the time it takes to perform the RSA decryption. This is particularly true of devices that do not have a fast cryptographic accelerator. Therefore, the overhead of swapping to NVM heap 311 is not that noticeable.

4. Message Authentication Code (MAC) Computations

TLS 1.0 specification requires that both client and server maintain a digest (hashed MAC) of all the messages they exchange during their handshake phase. This helps prevent any man-in-the-middle attacks on the TLS protocol. This digest is created by both MD5 and SHA-1 algorithms. MD5 and SHA-1 are two different algorithms that may be used for determining a condensed fixed length representation of a message. This representation is known as a digest. MD5 is described in “The MD5 Message-Digest Algorithm”, IETF Network Working Group RFC 1321, by R. Riverst, which is incorporated herein by reference. SHA-1 is described in “US Secure Hash Algorithm 1 (SHA1)”, IETF Network Working Group RFC 3174, by D. Eastlake, and P. Jones which is incorporated herein by reference. There are three approaches to get the final hash value: bulk digest, rolling digest, and optimized rolling digest. One embodiment of the invention uses the optimized rolling digest approach, which is the most suitable approach for resource-constrained devices.

Bulk Digest:

Some implementations of TLS concatenate all handshake messages in a dedicated global buffer and then use it to generate the digest in a single operation. On resource-constrained devices such as smart cards, limitation of the available RAM 300 and the performance overhead of writing to NVM 310, make concatenation of all messages in a large buffer an impractical solution.

Rolling Digest:

A somewhat better approach for resource-constrained devices is to maintain a rolling digest of all handshake messages. FIG. 10 is a message flow diagram illustrating the exchange of messages between a client and a server during a typical TLS handshake phase. According to TLS 1.0 specification the following handshake messages are added to the digest: 1001, 1002, 1003, 1004, 1005, 1007, and 1009. Each of these messages is added to the digest one at a time as it becomes available. Once all the messages are added, the digest is “finalized” by calling the finalize function of either the MD5 or SHA-1 algorithm on the messages to get the final hash value. finalize is a function that is called in either MD5 or SHA-1 to obtain a final hash value from a digest context.

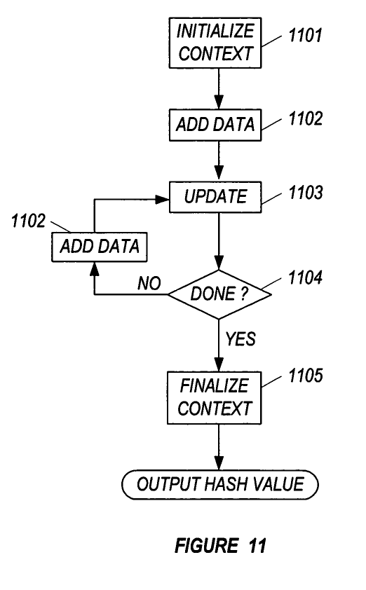

The sequence of getting a final hash value according to the Rolling Digest method is illustrated in FIG. 11. FIG. 11 shows the following steps of getting the hash value:

A new digest context structure is allocated and initialized, step 1101. This allocation is in the form of a memory buffer from the RAM heap 302.

A handshake message, (e.g. client-hello 1001), is added to the context. Step 1102

The internal state of the context is updated with this message. Step 1103.

Check (step 1104) if there are more messages to digest. If so go to step 1102, otherwise go to the step 1105.

When there are no more messages to digest, the context is finalized, step 1105, by calling the finalize method on the digest context. The finalization step produces the final hash value. After the finalization step the digest context cannot be used to add any more messages.

The rolling digest approach is quite useful for resource-constrained devices, but has one disadvantage when used in SSL/TLS module 103. The dilemma lies in the implementation of the TLS 1.0 protocol specification. The remote TLS client 1010 sends the client-finish message 1007 to the resource-constrained device. The TSH module 202 on the resource-constrained device receives this message (see FIG. 10). The client-finish message 1007 contains a MAC of all the messages exchanged so far. The following messages are included in this MAC: 1001, 1002, 1003, 1004, and 1005. To verify the MAC sent in message 1007, the TLS server finish (TSF) module 703 needs to finalize the hash context (step 1105 in FIG. 11) and then get the final output hash value. This value is then run through a pseudo random function according to the TLS 1.0 specification. The resulting value is then compared with the 12-byte value received in client-finish message 1007.

However, the TSH module 202 now has to send its own server-finish message, 1009, to the remote TLS client 1010. This message, according to the TLS 1.0 specification, contains the MAC of the following messages: 1001, 1002, 1003, 1004, 1005, and 1007. The problem is that the digest context maintained by the TSH module 202 has already been finalized during processing of the client-finish message 1007. As such the message 1007 cannot be added to the digest. To solve this dilemma several implementations of TLS maintain two separate digest contexts for each algorithm. Each message is added to both the contexts. One of the contexts is used when the TSF module 703 calls finalize during the processing of message 1007. The contents of message 1007 are then added to the second context. During the creation of server-finish message 1009 (sent from the TSH module 202 to the remote TLS client 1010) the TSF module 703 calls finalize on this second context. This approach is not suitable for resource-constrained devices since it requires two digest contexts and therefore poses a heavy burden on the limited RAM resources.

Optimized Rolling Digest:

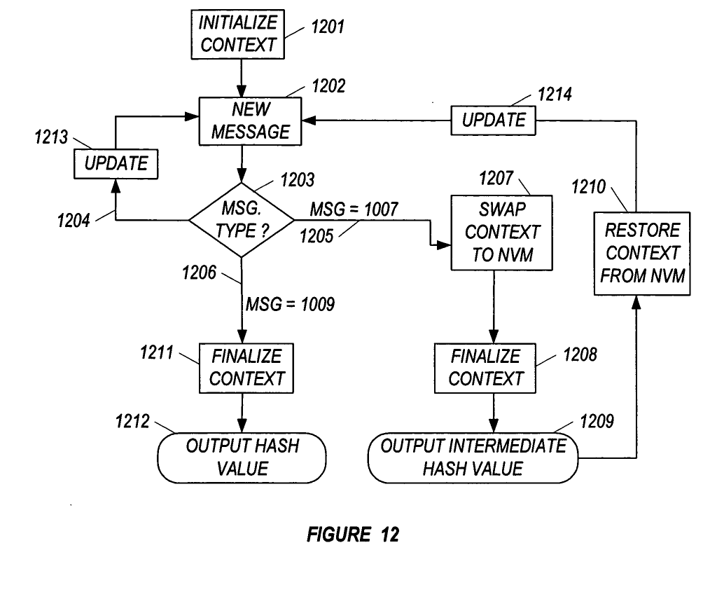

The optimized rolling digest technique supported in one embodiment of this invention solves the implementation dilemma of using a single digest context during the TLS handshake. FIG. 12 if a flow chart illustrating the sequence of steps for generating an intermediate hash value 1209 and then a final hash value 1212 from a single digest context. This saves the limited RAM resources on a resource-constrained device. The explanation of steps in FIG. 12 is given below:

A new digest context structure is allocated and initialized, step 1201. This allocation is in the form of a memory buffer from the RAM heap 302.

A new TLS handshake message is ready for processing (step 1202). The TLS handshake message has either been read from the remote TLS client 1010, or it is being created by the TSH module 202 and will be sent to the remote TLS client 1010.

The message number is checked to decide how to digest the message (step 1203). There are three distinct paths after this check. These paths are shown as 1204, 1205, and 1206 in FIG. 12.

Path 1204 is taken if the message is anything other than the client-finish message 1007, or the server-finish message 1009. In this case the TSH module 202 updates the digest with the message contents (step 1213) and then goes back to processing the next message (step 1202). Messages 1001, 1002, 1003, 1004 and 1005 are handled through this path.

Path 1205 is taken if the message is client-finish message 1007. The digest context is swapped to NVM heap (step 1207). finalize is called on the digest context (step 1208) to get the hash value 1209. This hash value is the intermediate digest value, which is used for comparing the corresponding value sent by the remote TLS client 1010. Once this comparison is complete, the digest context is restored from the NVM heap (step 1210). The client-finish message 1007 is now added to the digest context by calling the update method (step 1214). The update method is a method of a function library implementing the digest algorithm, e.g., the MD5 library or SHA-1 library. The update method updates the digest context with a new message. The TSH module 202 now goes back to processing the next message (step 1202).

Path 1206 is taken if the message is server-finish message 1009. This is the last message of the full TLS handshake. Finalize is called on the digest context (step 1211) to get the hash value, step 1212. This hash value is the final digest value, which is sent to the remote TLS client 1010 as part of the server-finish message 1009. Once this message 1009 is sent, the digest context is not required and its memory buffer can be released back to the RAM heap 302.

5. Reading Application Data

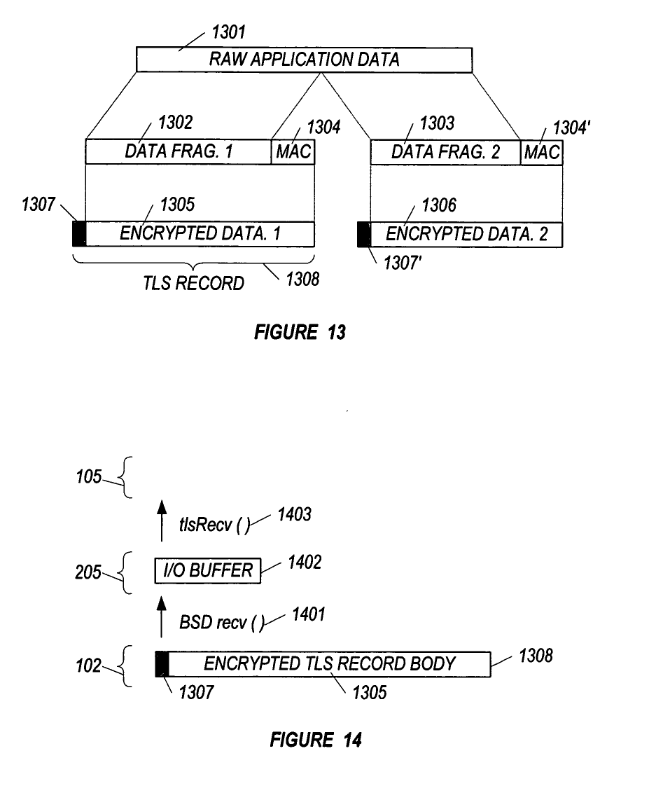

Once the TLS handshake phase is completed successfully, both the client and the server can send application data to each other. FIG. 13 is an illustration of the TLS record protocol and describes how application data is formatted as TLS records for transmission. During the data transfer phase raw application data 1301 is divided into segments; e.g., data segment A 1302, and data segment B 1303. A MAC is then appended to each of these segments; e.g., 1304 and 1304_. The resulting record (i.e. concatenation of the data segment and its MAC) is encrypted using the session keys and algorithms established during the TLS handshake as described in conjunction with FIG. 10. The encrypted records are shown as 1305 and 1306 in FIG. 13.

As a final step, a TLS record header is then attached to each record. This header is shown as 1307 and 1307_in FIG. 13. The encrypted payload 1305, consisting of an application data segment and its MAC, and the unencrypted header 1307 are collectively referred to as the TLS record 1308. It is this TLS record that is actually transmitted using the underlying TCP/IP communication layer. The header 1307 contains information about the size of the encrypted record payload 1305.

The TLS record formatting poses an implementation problem for resource-constrained devices such as smart cards. The challenge, which is illustrated in FIG. 14, is to process a larger TLS record 1308 using a much smaller data buffer 1402. The encrypted data is read from the socket layer 102 through a BSD socket style ‘recv’ call 1401, and then passed on to the application layer (e.g., a secure web server 105) through tlsRecv call 1403. The tlsRecv call is part of the secure socket API 104 provided by the SSL/TLS module 103.

One embodiment of this invention supports a unique set of design optimizations whereby a smaller data buffer 1402 can be used to process a much larger TLS record 1308. The TLS record 1308 can typically be several kilobytes in size. On the other hand, the data buffer 1402 used by the data I/O module 205 can be as small as only 200 bytes. This size disparity can be addressed by either of the two distinct approaches:
1. Performance critical approach
2. Error critical approach

Each approach has its own advantages. The data I/O module 205 supports both these approaches. An application can pick either one to suite its needs. The details of each approach are described herein.

Performance Critical Approach:

In the performance critical approach, an application can request that the data I/O module 205 make data available to the application as soon as data is read. At this point, the TLS record 1308 may not have been completely read and, therefore, the MAC 1304 over the entire TLS record 1308 may not have been verified. The application, however, accepts the delayed notification of MAC verification to get faster access to data.

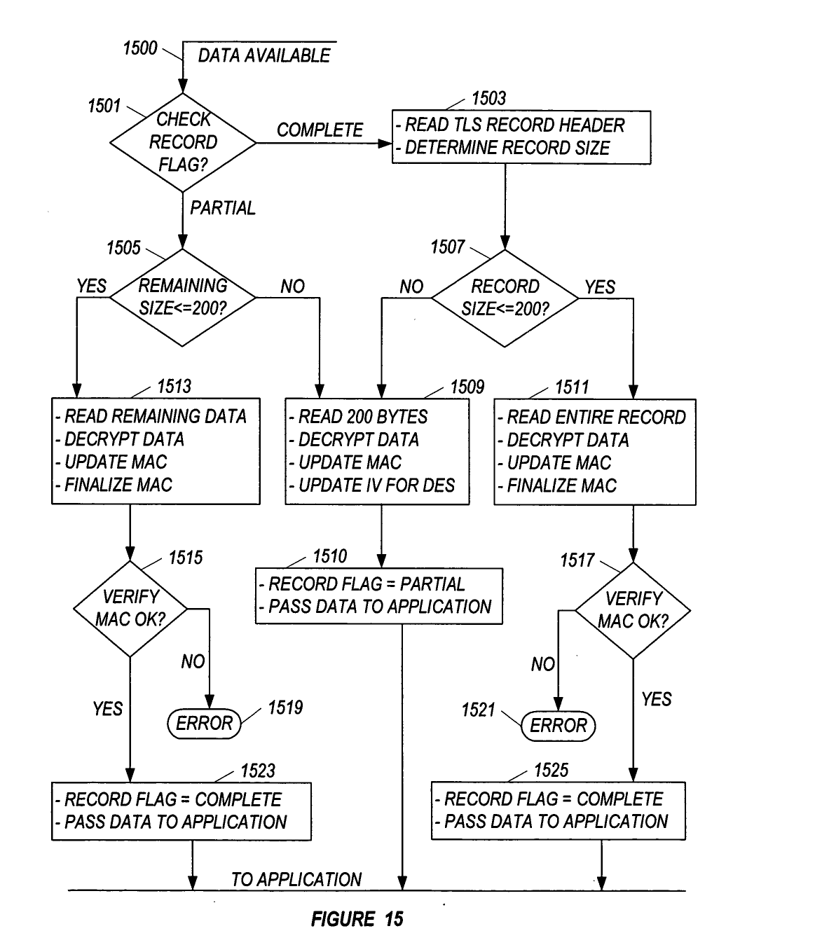

FIG. 15 is a flow chart of a first method, the performance critical approach to reading large TLS records while using a small TLS I/O buffer in which preference is given to performance. In this approach the data I/O Module 205 reads the TLS record 1308 in blocks of 200 (or less) bytes. The data I/O module maintains a global flag, Record Flag, to indicate whether the processing of the TLS record 1308 is complete, or is only partially done. Each time new data is available and ready to be read, step 1500, the data I/O Module 205 checks the Record Flag, step 1501. If the Record Flag value is COMPLETE, the new data that is about to be read belongs to a new TLS record. The record header is read to determine the size of this new record, step 1503. If the Record Flag value is PARTIAL, the new data belongs to the TLS record that is currently being processed.

Either way, if the remaining number of bytes (step 1505) or the record size (step 1507) is greater than the size of the TLS I/O buffer 1402 (in one embodiment of this invention the size of the TLS I/O buffer is set to 200 bytes), the data I/O module 205 reads as many bytes as would fit in the TLS I/O buffer 1402 (e.g., 200 bytes). The data is then decrypted and the rolling MAC is updated. If using DES in CBC mode, the initialization vectors are also updated. This is shown as step 1509. The Record Flag value is then marked as PARTIAL, and the most recently read data is passed on to the application, step 1510.

On the other hand, if the remaining number of bytes (step 1505) or the record size (step 1507) is not greater than the size of the TLS I/O buffer 1402, the entire record is read, step 1511, or the remaining data is read, step 1513. In both these steps (1511 and 1513) the data is decrypted and MAC is updated. Since the entire TLS record has now been read, the data I/O module 205 can verify the MAC integrity. This check is shown in steps 1517 and 1515.

If the MAC verification fails an error is flagged, as shown in steps 1519 and 1521. If the MAC verification succeeds, the Record Flag is marked as COMPLETE and data is passed on to the application. This is shown in step 1523 and 1525. The next read from the underlying communication layer 101 will now yield a new TLS record.

In this performance critical approach the application layer obtains data as soon as the data is read, without having to pay the penalty of a larger RAM buffer. However, since MAC verification is not possible until the entire TLS record 1308 has been read, any errors in secure transmission are not flagged until the entire TLS record has been read and the MAC verification checks of steps 1517 and 1515 are performed. In most applications this slight delay in receiving a transmission error is acceptable, particularly if the application explicitly requests this behavior to improve performance.

Error Critical Approach:

In the error critical approach, the application can request that no data should be passed to it unless MAC integrity has been verified over the entire TLS record 1308. This is a safer application interface, but the application has to wait for data until the entire TLS record has been processed.

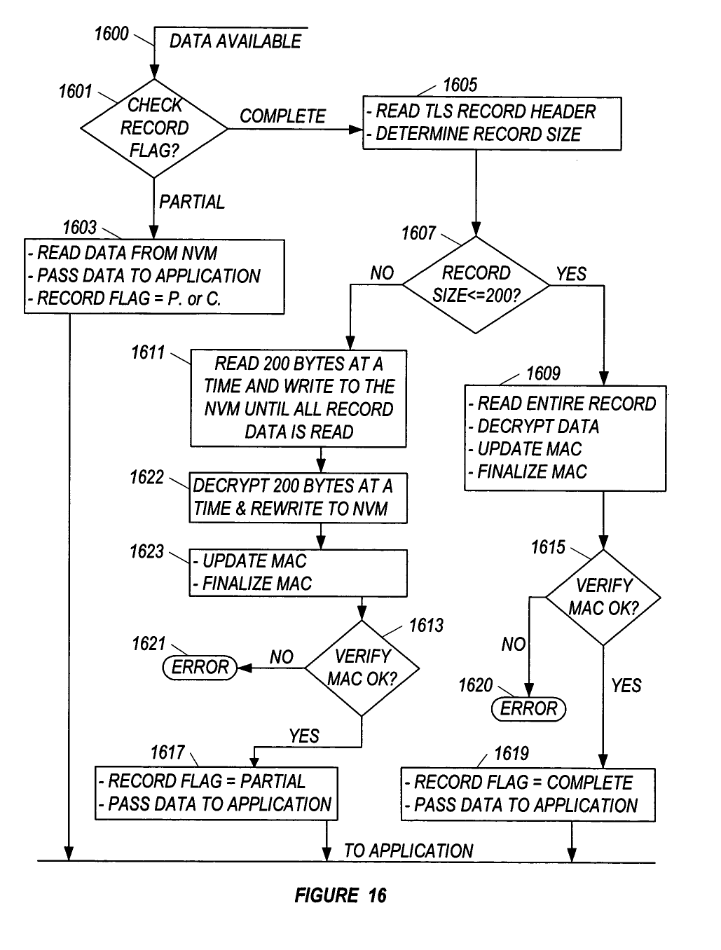

FIG. 16 is a flow-chart of a second method, the error critical approach, to reading large TLS records while using a small TLS I/O buffer in which preference is given to avoiding error conditions. In this approach, the data I/O Module 205 successively reads the entire TLS record 1308 in blocks of 200 (or less) bytes. Each time a block of data is read, it is written to a buffer in NVM heap 311. This is repeated until the entire TLS record has been written to NVM heap 311. The MAC integrity of this complete TLS record is verified before data is passed on to the application.

As in the performance critical approach, the data I/O module maintains a global flag, Record Flag, to indicate whether the processing of the TLS record 1308 is complete, or is only partially done. Each time new data is available and ready to be read, step 1600, the data I/O Module 205 checks the Record Flag, step 1601. If the Record Flag value is COMPLETE, the new data that is about to be read belongs to a new TLS record. The record header is read to determine the size of this new record, step 1605.

If the record size (check 1607) is not greater than the size of the TLS I/O buffer 1402, the entire record is read, step 1609. In the same step, the record data is decrypted and the MAC is both updated and finalized. Since the entire TLS record has been read, the data I/O module 205 can verify the MAC integrity. This check is shown in step 1615. If the MAC verification fails, an error is flagged, step 1620. If, however, the MAC verification succeeds, the current Record Flag is marked as COMPLETE and the data is passed on to the application, step 1619. The next read from the underlying communication layer 101 will now yield a new TLS record.

If, however, the record size (check 1607) is greater than the size of the TLS I/O buffer 1402, the data I/O Module 205 successively reads as many bytes as will fit into the TLS I/O buffer 1402 (one embodiment of the invention sets this buffer size to 200 bytes), and writes that data to a dedicated buffer that has been allocated in the NVM heap 311. This process is repeated until the entire TLS record has been written to the NVM heap, step 1611. The data written to NVM heap is then read in blocks that will fit in the TLS I/O buffer 1402 (e.g. 200 bytes) and decrypted using the currently selected cipher suite and session keys. This data is then written back to the NVM heap 311, step 1622. The data I/O module 205 now updates the data MAC and then calls finalize on the digest context, step 1623. If the verify MAC check, step 1613, fails, an error is flagged and no data is passed to the application, step 1621. However, if the verify MAC check, step 1613, succeeds, the Record Flag is set to PARTIAL and data is passed on to the application, step 1617.

If the Record Flag value in step 1601 is PARTIAL, the new data belongs to the TLS record that is currently being processed. Data is simply read from the NVM heap 311 and passed on to the application, step 1603. In this step the data I/O module 205 also sets the Record Flag value to either PARTIAL or COMPLETE. The value is set to PARTIAL if there is still more data in the NVM heap for this TLS record. The value is set to COMPLETE if all the data for this TLS record has been read from the NVM heap and passed on to the application.

This approach provides a much safer application interface since no data is passed on to the application without verification of MAC and data integrity. However, since it requires the overhead of writing to NVM heap 311, this approach is slower than the performance critical approach.

6. TLS API

The secure socket API 104 exposes the functionality of the SSL/TLS module 103 to applications—such as the secure web server 105—running on the resource-constrained device. These APIs hide all the details of the TLS 1.0 protocol implementation. The secure socket API layer 104 consists of the following functions:
tlsResetCtx
tlsAccept
tlsSend
tlsRecv

Each of these functions is described in subsequent sections.

tlsResetCtx:

This function does the work of resetting a specified TLS context. The context is allocated using a memory buffer from RAM heap 302. The context is reset in any one of three possible ways depending upon the value of the flag argument. The complete signature of this function is:
s_int8 tlsResetCtx(tlsContext_t *tlsCtx, u_int8 flag);

In the function definition, tlsCtx is a pointer to the TLS context data structure that needs to be reset. The flag argument dictates how the reset should work. It can have the following values:

TLS_RESET_INIT. When flag is set to this value, the TLS context is initialized for first time use. The process consists of resetting MD5 and SHA1 contexts, clearing record header information, clearing the input/output buffer, and initializing other data fields that maintain the state of TLS context both during the handshake phase and the actual application data transfer phase.

TLS_RESET_RSA. When flag is set to this value, the TLS context information is saved to NVM heap 311 so that the RAM buffer occupied by the TLS context can be reassigned for other tasks—in this case for RSA computation.

TLS_RESET_TLS. When flag is set to this value, the TLS context information is retrieved from NVM heap 311 and restored to the original RAM buffer.

This function returns either TLS_SUCCESS or TLS_ERROR to indicate success or error respectively.

tlsAccept:

This function does the critical task of performing TLS handshake with the remote TLS client 1010. It negotiates a cipher suite and establishes various session keys for actual data exchange as illustrated in FIG. 10. Both full and partial handshakes are handled in this function. The decision on whether to do full handshake, or perform a computationally less expensive partial handshake, is taken dynamically during the initial stage of handshake message exchange with the remote TLS client 1010. The complete signature of this function is:
s_int8 tlsAccept(tlscontext_t *tlsCtx);

The tlsCtx argument is a pointer to the TLS context data structure. The function returns either TLS_SUCCESS or TLS_ERROR to indicate success or error respectively.

tlsSend:

This function is the equivalent of the BSD socket API ‘send’ call. It uses the underlying communication layer 101 to transmit application data. The data is encrypted using the agreed upon cipher suite and session keys. Users of this function are expected to have first called the tlsAccept function to establish a valid TLS session. The complete signature of this function is:
s_int16 tlsSend(tlsContext_t *tlsCtx, unsigned char *pData,
s_int16 size, u_int8 flag);

In the function definition, tlsCtx is a pointer to the TLS context data structure, pData is the starting address of data to be sent, size is the length in bytes of data to be sent, and flag is an optimization flag to allow buffer sharing on resource-constrained devices.

The flag argument can be set to the following two options:
TLS_COPY_OFF
TLS_COPY_ON

To save RAM buffers, the data I/O module 205 uses I/O buffer 1402 from the TLS context data structure to prepare the encrypted TLS record 1308 for transmission. When the flag option is set to TLS_COPY_ON, the raw data pointed to by pData is copied to this TLS context I/O buffer 1402 at the appropriate location. It is the caller's responsibility to allocate space for raw data. However, due to the limited RAM buffer on a resource-constrained device, callers may want to use the same TLS context I/O buffer to gather the raw data in the first place. One embodiment of this invention makes this possible using the following rules:

Set flag argument to TLS_COPY_OFF. The starting address of raw application data should be the 14th byte of the TLS context I/O buffer 1402. The first 13 bytes are reserved for use by data I/O module 205 as it prepares the raw data for encryption.

The trailing 28 bytes of the TLS context I/O buffer 1402 should not be used by application raw data. These bytes are reserved for padding data and for appending MAC digest 1304 while formatting the TLS record 1308.

Because of the above stated rules, the size argument should be at least 41 bytes less than the size of TLS context I/O buffer 1402. If size argument is greater than this value, and TLS_COPY_OFF flag is used, the complete data will not be sent.

The return value of this function indicates the size of the raw application data sent to remote TLS client 1010. This is not the size of actual data written to the underlying communication layer 101. The actual data includes TLS record header 1307 as well as the encryption and MAC 1304 overhead. In case of an error the function returns −1.

tlsRecv:

This function is the equivalent of the BSD socket API ‘recv’ call. It decrypts the incoming application data using the currently established TLS cipher suite and session keys. Users are expected to have first called the tlsAccept function to establish a valid TLS session. The complete signature of this function is:
s_int16 tlsRecv(tlsContext_t *tlsCtx, unsigned char **pData,
s_int16 size, u_int8 flag);

In the function definition, tlsCtx is a pointer to the TLS context data structure, pData is the pointer that receives the in coming data, size is the length in bytes of data to be read, and flag is an optimization flag for resource-constrained devices. In one embodiment of the invention the flag argument can be set to the following two options:

TLS_RECV_FAST. When this flag is used, and the size of the incoming TLS record 1308 is larger than that of TLS context I/O buffer 1402, data is returned to caller without verifying the integrity of MAC. The MAC is verified downstream once all the data in TLS record 1308 has been read. The MAC verification status is, therefore, deferred to make data access fast for the calling application.

TLS_RECV_SAFE. When this flag is used, the data I/O module 205 first reads the entire TLS record 1308 into a dedicated buffer in the NVM heap 311. The integrity of the message is verified by comparing the MAC of TLS record 1308. The decrypted data is then returned to the calling application. This approach is safe but slow for the first data access. Subsequent data requests on the same TLS record 1308 are fast since they only require reading from the NVM heap 311, and not writing to it.

Upon return from this function, pData points to the start of decrypted data inside TLS context I/O buffer 1402. It is the caller's responsibility to copy this data to a separate buffer if required. The data I/O module 205 overwrites the TLS context I/O buffer 1402 at the next tlsRecv call. This function returns the number of plain text bytes that were read and are accessible through pData pointer. In case of an error, the return value is −1.

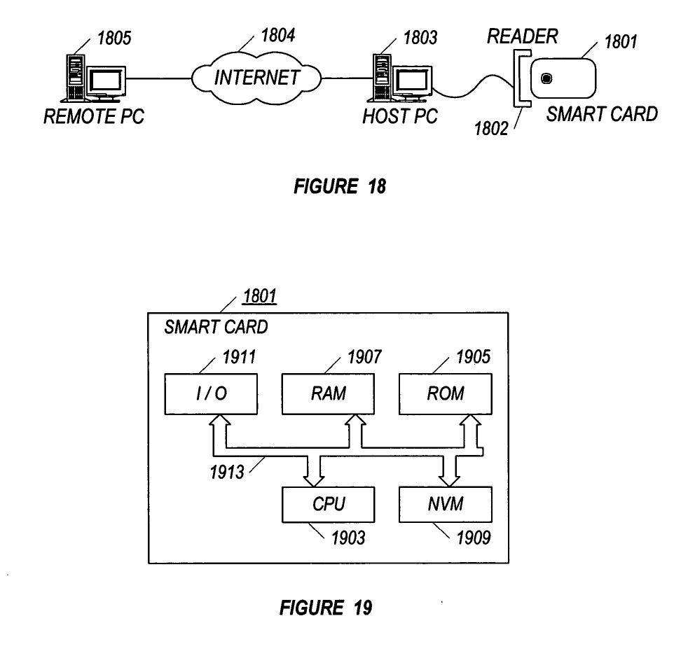

FIG. 18 is a schematic illustration of the operating environment in which a resource-constrained device according to the invention may be used to provide secure communication with a remote entity. A resource-constrained device 1801, for example, a smart card, is connected to a computer network 1804, for example, the Internet. The resource-constrained device 1801 may be connected to the computer network 1804 via a personal computer 1803 that has attached thereto a card reader 1802 for accepting a smart card. However, the resource-constrained device 1801 may be connected in a myriad of other ways to the computer network 1804, for example, via wireless communication networks, smart card hubs, or directly to the computer network 1804. The remote node 1805 is a computer system of some sort capable to implement the client portions of the SSL or TLS protocols. For example, the remote node 1805 may be executing a web browser that is running an SSL client or TLS client.

FIG. 19 is a schematic illustration of an exemplary architecture of a resource-constrained device 1801. The resource-constrained device 1801, e.g., a smart card has a central processing unit 1903, a read-only memory (ROM) 1905, a random access memory (RAM) 1907, a non-volatile memory (NVM) 1909, and a communications interface 1911 for receiving input and placing output to a device, e.g., the card reader 1802, to which the resource-constrained device 1801 is connected. These various components are connected to one another, for example, by bus 1913. In one embodiment of the invention, the SSL/TLS module 103, as well as other software modules shown in FIG. 1, would be stored on the resource-constrained device 1801 in the ROM 1906. The ROM 1905 would also contain some type of operating system, e.g., a Java Virtual Machine. Alternatively, the SSL/TLS Module 103 would be part of the operating system. During operation, the CPU 1903 operates according to instructions in the various software modules stored in the ROM 1905.

Thus, according to the invention the CPU 1903 operates according to the instructions in the SSL/TLS module 103 to perform the various operations of the SSL/TLS module 103 described herein above.

Although specific embodiments of the invention has been described and illustrated, the invention is not to be limited to the specific forms or arrangements of parts so described and illustrated. For example, the invention is applicable to other resource-constrained devices and is applicable to other communications protocols. The invention is limited only by the claims.

Appendix A: Overview of the TLS 1.0 Protocol

This appendix gives a brief overview of the TLS 1.0 protocol. For more details the reader should see the following Internet standard document: Dierks, T., Allen, C., “The TLS Protocol, Version 1.0”, IETF Network Working Group. RFC 2246. See the URL http://www.ietforg/rfc/rfc2246.txt.

The basic design of TLS 1.0 protocol has a notion of two distinct phases: the handshake phase and the data transfer phase. During the handshake phase, the client authenticates the server while the server can optionally authenticate the client. They both establish a set of cryptographic keys, which are then used to secure the data during application phase. The handshake phase must complete successfully before the application data exchange can take place.

TLS 1.0 Handshake

FIG. 10 is a schematic illustration of the sequence of messages that are exchanged during a typical TLS handshake phase. The two communicating nodes have specific roles as the client or the server.

The client-hello message 1001: The client side (e.g. remote TLS client 1010) initiates a TLS handshake by sending the server a client-hello message 1001. This message includes the proposed protocol version, a list of cipher suites supported by the client, and a client random number that will be used in the key generation process.

The server-hello message 1002: The server side responds with this message, which has the following information: the selected protocol version, the selected cipher suite, a server random number that is used in the key generation process, and a session ID which can be used later by the client in its client-hello message 1001 to speedup subsequent TLS handshakes.

The certificate message 1003: The server then sends its public key certificate in the certificate message 1003. This allows the client side to authenticate the server, and also to get its public key.

The server-hello-done message 1004: The server then sends this message to indicate to the client that the client should go ahead with its validation of the two earlier messages 1002, and 1003 that were sent to it.

The client-key-exchange message 1005: The client sends the server this message to begin the process of session key exchange. This message has a pre-master-secret that has been encrypted using the public key of the server. The server public key was sent in the certificate message 1003. The server side decrypts the pre-master-secret using its private key. At this point both the client and the server have all the data they need to generate a set of session keys. The session keys are generated by using a pseudo random function (PRF) as defined in the TLS 1.0 specification. There are three inputs to this PRF: the client random number (see message 1001), the server random number (see message 1002), and the pre-master-secret.

The change-cipher-spec message 1006: The client sends this message to indicate to the server that it is ready to send data using the agreed upon cipher suite and session keys.

The client-finish message 1007: The client then sends this message to indicate that it is done with the handshake. This message is encrypted using the cryptographic algorithm and keys selected during the TLS handshake. The message body consists of a digest of all the handshake messages exchanged so far: that is messages 1001, 1002, 1003, 1004, and 1005. The change-cipher-spec message 1006 is not added to the digest.

The change-cipher-spec message 1008: The server also sends this message to indicate that it is ready to send messages using the agreed upon cipher suite and session keys.

The server-finish message 1009: Finally the server sends a corresponding server-finish message to the client. This message is encrypted using the selected cipher suite, and session keys. The message body consists of a digest of all the handshake messages exchanged so far: that is messages 1001, 1002, 1003, 1004, 1005, and 1007. The change-cipher-spec messages 1006 and 1008 are not added to the digest.

Appendix B: Overview of the SSL 2.0 Protocol

This appendix gives a brief overview of the SSL 2.0 protocol. For more details the reader should see the SSL version 2.0 specification document at the following Netscape website:

http://wp.netscape.com/eng/security/SSL_{—}2.html.

As with TLS 1.0 protocol, the basic design of SSL 2.0 protocol has a notion of two distinct phases: the handshake phase and the data transfer phase. During the handshake phase, the client authenticates the server while the server can optionally authenticate the client. They both establish a set of cryptographic keys, which are then used to secure the data during application phase. The handshake phase must complete successfully before the application data exchange can take place. The SSL 2.0 protocol allows the use of shorter asymmetric keys as compared to the TLS 1.0 protocol, and can therefore be used in extremely low-end resource-constrained devices. Examples of such devices are smart cards without cryptographic accelerators.

SSL 2.0 Handshake

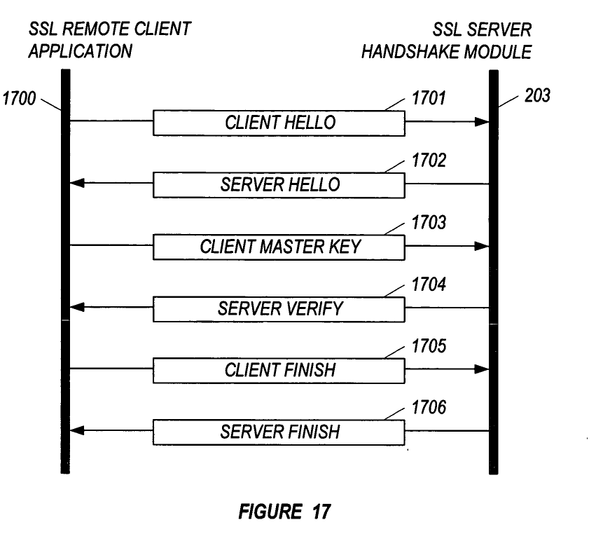

FIG. 17 is a message flow diagram illustrating the sequence of messages in a typical SSL 2.0 handshake. The two communicating nodes have specific roles as the client or the server.

The client-hello message 1701: This is the first message of the handshake process. The remote SSL client sends this message in the clear to initiate a new SSL session. The message contains a challenge and a list of cipher suites.

The server-hello message 1702: In response, the SSH module 203 sends the server-hello message 1702. This message is also sent in the clear and contains the following: a connection ID, the server public-key certificate, and a list of cipher suites supported by the server. Unlike the TLS 1.0 protocol, in SSL 2.0 protocol the final decision on which cipher suite to use for a given SSL session rests with the client. The server can only provide a list of cipher suites that it can support. However, it is acceptable for the server to provide only one cipher suite in its list, thereby forcing the client to use it.

The client-master-key message 1703: In this message, the remote SSL client 1700 encrypts a master secret using the server's public key. This public key was sent to the client in the server-hello message 1702. The server decrypts this message using its private key and extracts the master secret. At this point both the server and the client can independently generate various session keys.

The server-verify message 1704: This is the first message that is encrypted using the agreed upon security parameters and session keys. The server sends the challenge it received in client-hello message 1701, back to the client.

The client-finish message 1705: In response, the client sends the connection ID it received in the server-hello message 1702, back to the server.

The server-finish message 1706: Finally, the server sends a new encrypted session ID to the client.

This completes the SSL handshake to establish a new set of session keys. There is another form of handshake, partial handshake, which reuses the existing master secret to refresh the session keys. That form of handshake is not discussed here. The reader should see the SSL 2.0 specification for the sequence of messages in the partial handshake.

What is claimed is the following:

1. A method of providing secure communication between a resource constrained device and a remote node over a computer network, comprising:
supporting an SSL/TLS protocol stack on the resource-constrained device by performing at least one optimization step to reduce the resources required to support the SSL/TLS protocol stack on the resource constrained device.

2. The method of claim 1 wherein the optimization step comprises:
memory management optmization wherein stack depth is minimized by reducing data passed via function calls.

3. The method of claim 2 wherein the stack depth is reduced by allocating variables on a RAM heap.

4. The method of claim 1 wherein the optimization step comprises a memory management optimization including RAM heap management wherein freed memory blocks are made available for subsequent memory requests.

5. The method of claim 4 further comprising placing freed memory blocks in a linked list and in response to a memory request, seeking the linked list for a suitable available memory block.

6. The method of claim 4 wherein the optimization step comprises:
maintaining a startpointer indicating the location of a next free memory buffer;
in response to a request to allocate a memory buffer of size n, searching the RAM heap beginning at the startpointer for a memory buffer of size n, by:
examining the size of the memory buffer pointed to by the startpointer, if the memory buffer pointed to by the startpointer smaller than n, moving the startpointer to the next free RAM heap block and continue searching, otherwise, allocate a memory buffer of size n located at the end of the RAM block pointed to by the startpointer.

7. The method of claim 4 wherein the optimization step comprises:
in response to a request to release a previously allocated block, determining whether an adjacent block is freeand if the adjacent block is free, combine the adjacent block with the block being freed whereby forming a larger contiguous block.

8. The method of claim 4 wherein the optimization step comprises:
reusing an allocated buffer without returning the buffer to the RAM heap.

9. The method of claim 8 wherein the step of reusing an allocated buffer comprises storing a pre-master secret and a master secret in a common buffer during TLS handshake phase.

10. The method of claim 8 wherein the step of reusing an allocated buffer comprises storing a pre-master secret in a global I/O buffer used for reading all incoming TLS messages.

11. The method of claim 8 wherein the step of reusing an allocated buffer comprises performing DES encryption and decryption using a single RAM heap buffer for both input and output.

12. The method of claim 1 wherein the optimization step comprises:
swapping unused data from the RAM to a non-volatile memory (NVM) heap.

13. The method of claim 12 wherein the swapping of unused data comprises:
selecting a first buffer from the RAM heap for swapping to NVM wherein the first buffer contains data from a first process;
allocating a second buffer in the NVM;
writing the contents of the first buffer into the second buffer;
permitting a second process requiring use of RAM to use the first buffer;
operating the second process and using the first buffer to store data from the second process up to a state in which the second process no longer requires use of the first buffer;
reading the data from the second buffer and writing the data into the first buffer.

14. The method of claim 12 wherein the swapping of unused data comprises selecting for swapping only RAM buffers sufficiently large to justify overhead associated with swapping.

15. The method of claim 12 wherein the swapping of unused data comprises selecting for swapping only RAM buffers that do not contain data that are required concurrently.

16. The method of claim 1 wherein the optimization step comprises:
computing a message authentication code (MAC) digest using a single digest context during TLS handshake with a remote TLS client.

17. The method of claim 16 wherein the computing message authentication code (MAC) step comprises generating an intermediate hash value and a final hash value from a single digest context.

18. The method of claim 17 wherein the step of generating an intermediate hash value and a final value from a single digest context comprises:
(a) allocating and initializing a new digest context;
(b) in response to a new handshake message, check the message number and determine how to digest the message;
(c) if the message is anything other than a client-finish message or server—finish message, update the digest with the message contents and return to step (b);
(d) if the message is a client-finish message:
swap the digest to a non-volatile memory (NVM) heap;
finalize the digest context to obtain a hash value (the intermediate digest value);
compare the intermediate digest value to a corresponding value received from the remote TLS client;
restore the digest context from the NVM heap;
update the digest by adding the client-finish message to the digest;
return to step (b);
(e) if the message is a server-finish message:
finalize the digest context to obtain a hash value (the final digest value);
transmit the final digest value to the remote TLS client;
release the RAM buffer for the digest context back to the RAM heap.

19. The method of claim 1 wherein the optimization step comprises:
receiving a TLS record to be passed on to an application as a sequence of blocks;
for each block, write the block to a non-volatile memory heap;
verify message authentication code (MAC) integrity on the entire record;
if the MAC integrity is confirmed, pass the TLS record to the application.

20. The method of claim 1 wherein the optimization step comprises:
receiving a TLS record to passed on to an application as a sequence of blocks;
maintain a global flag indicating whether the entire TLS record has been received;
for each block received and the global flag indicates that the entire TLS record has not been received, the block is passed to the application;
if the entire record is read or the remaining data is read, then:
verify message authentication code (MAC) integrity on the entire record; and
if the MAC integrity is confirmed, set the global flag to indicate that the complete record has been received and pass the block of data to the application;
if the MAC integrity fails, an error flag is set.
